(19) United States
(12) Patent Application Publication
(10) Pub. No.: US 2004/0198916 A1
(43) Pub. Date: Oct. 7, 2004

(54) Method for producing polymers for ophthalmic lens and ophthalmic lens

(76) Inventors: Masataka Nakamura, Otsu-shi (JP); Yukie Morikawa, Kusatsu-shi (JP); Masataka Nakamura, Otsu-shi (JP)

Correspondence Address: PHILIP S. JOHNSON, JOHNSON & JOHNSON, ONE JOHNSON & JOHNSON PLAZA, NEW BRUNSWICK, NJ, 08933-7003, US

(21) Appl. No.: 10/487,323

(22) PCT Filed: Aug. 17, 2001
(86) PCT No.: PCT/JP01/07077

(51) Int. Cl. C08F 120/56

(52) U.S. Cl. 525/329.4; 525/329.7

(57) ABSTRACT

This invention has the objective of providing polymers for ophthalmic lenses having high oxygen permeability and superior surface wettability. It relates to a method for the manufacture of polymers for ophthalmic lenses characterized in that the polymers are formed by reacting a polymer comprising, as a polymerization component, at least one monomer (a) having organosiloxane groups and a polymerizable group having a carbon-carbon unsaturated bond with a hydrophilic component (b).

### TECHNICAL FIELD

This invention relates to a method for the manufacture of polymers that can be used suitably in ophthalmic lenses such as contact lenses, intraocular lenses and artificial cornea, and to ophthalmic lenses.

### PRIOR ART

In recent years, polymers of which one component is modified polysiloxanes and methacrylates containing siloxanyl groups such as tris(trimethylsiloxy) silylpropyl methacrylate have been developed and used as polymers for ophthalmic lenses having high oxygen permeability (Japanese Patent Application Laid-Open No. 60[1985]-142324 and Japanese Patent Application Laid-Open No. 54[1979]-24047).

However, the surface of polymers comprising these monomers or macromers have poor wettability because of the effects of siloxanyl groups or polysiloxane components that are introduced for the purpose of increasing oxygen permeability, and said polymers have not been desirable as polymers for ophthalmic lenses.

Further, when polymers are prepared by copolymerizing monomers of high water-absorbing capacity such as (meth)acrylic acids (or metal salts thereof) with the aforementioned monomers or macromers for the purpose of improving wettability, the water content enormously increased, and there has, as a result, been the drawback that oxygen permeability is decreased.

### DISCLOSURE OF THE INVENTION

This invention was developed for the purpose of eliminating the drawbacks of the conventional art and has the objective of providing polymers for ophthalmic lenses that have both high oxygen permeability and superior surface wettability.

The method of manufacture of polymers for ophthalmic lenses of this invention is a method of manufacture of polymers for ophthalmic lenses in which a polymer of which the polymerization component is monomer (a) having organosiloxane groups and a polymerizable group having a carbon-carbon unsaturated bond is reacted with a hydrophilic component (b).

Further, the ophthalmic lens of this invention is an ophthalmic lens comprising polymers which are formed by chemical bonding of a polymer of which the essential polymerization component is at least one monomer (a) selected from a group represented by formula (I) with at least one hydrophilic component (b) selected from acid anhydride, compounds represented by formula (III) and compounds represented by formula (IV):

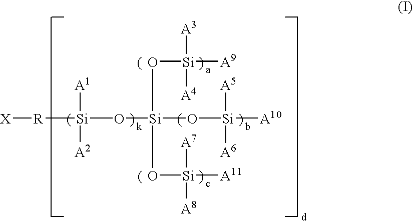

wherein, in formula (I), X is a polymerizable group having carbon-carbon unsaturated bonds; R is an alkyl group that may contain ether bonds and that may be substituted; A¹ to A¹¹ are selected from H, alkyl groups that may be substituted and aryl groups that may be substituted; k is an integer of 0 to 10; a, b and c are, respectively and independently, integers of 0 to 10, excepting the case k=a=b=c=0; and d is an integer of 1 or 2;

CH₂═CH—CH₂—O(CH₂CH₂O)ᵣ R⁴¹ (III)

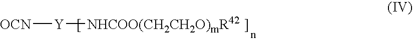

wherein, in formulas (III) and (IV), r is an integer of 0 to 500; R⁴¹ is hydrogen or an alkyl group that may be substituted; m is an integer of 1 to 500; Y is a residue obtained by eliminating NCO groups from isocyanate compounds having two or more functionality; and R⁴² is an alkyl group that may be substituted.

### EMBODIMENT OF THE INVENTION

We shall now describe the embodiment of this invention. The method of this invention is a method of manufacture of polymers for ophthalmic lenses in which a polymer of which the polymerization component is monomer (a) having organosiloxane groups and a polymerizable group having a carbon-carbon unsaturated bond is reacted with a hydrophilic component (b).

It is desirable that the monomers (a) that are used in this invention be compounds represented by formula (I) below:

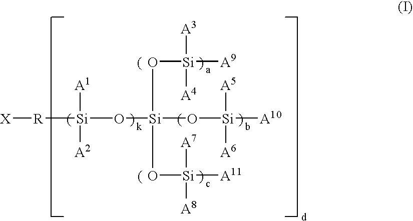

wherein, in formula (I), X is a polymerizable group having carbon-carbon unsaturated bonds; R is an alkyl group that may contain ether bonds and that may be substituted; A¹ to A¹¹ are selected from H, alkyl groups that may be substituted and aryl groups that may be substituted; k is an integer of 0 to 10; a, b and c are, respectively and independently, integers of 0 to 10, excepting the case k=a=b=c=0; and d is an integer of 1 or 2.

The polymerizable group X, in formula (I), which has carbon-carbon unsaturated bonds may be any group as long as it is polymerizable and can include (meth)acrylic acid derivatives, styrene derivatives, (meth)acrylamide derivatives and vinyl ester derivatives. Of these, the use of groups represented by formulas (x1) and (x2) below is desirable:

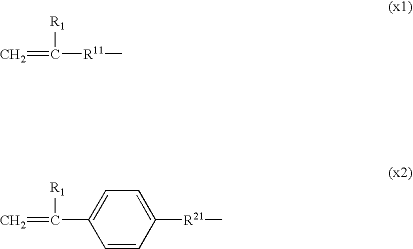

wherein, in formulas (x1) and (x2), R₁ is H or a methyl group; R¹¹ is —COO—, —CONHCONR³¹—and —CONR³¹—; R²¹ is a direct bond and —CONR³¹—; and R³¹ is a substituent that can be selected from a hydrogen atom, an alkyl group that may be substituted and an aryl group that may be substituted.

The alkyl groups, in R³¹, that may be substituted may be straight chain or branched chain and there are no particular limitations on them. Specific examples that can be cited include methyl groups, ethyl groups, propyl groups, isopropyl groups, butyl groups, hexyl groups, benzyl groups, phenethyl groups, hydroxymethyl groups, 2-hydroxyethyl groups, 2-hydroxypropyl groups, 3-hydroxypropyl groups, 2,3-dihydroxypropyl groups, 2-hydroxybutyl groups, 4-hydroxybutyl groups, 2-hydroxypentyl groups, 5-hydroxypentyl groups, 2-hydroxyhexyl groups, 6-hydroxyhexyl groups, 3-methoxy-2-hydroxypropyl groups, 3-ethoxy-2-hydroxypropyl groups, 3-[tris(trimethylsiloxy)silyl]propyl groups, 3-[bis(trimethylsiloxy)methylsilyl]propyl groups, 3-[trimethylsiloxydimethylsilyl]propyl groups and cyanoethyl groups. Of these, the use of substituents having hydroxyl groups is desirable from the standpoint of the reaction with the hydrophilic component (b).

There are no particular limitations on the aryl groups that may be substituted. However, those with 6 to 20 carbon atoms are preferable. Specific examples include phenyl groups, naphthyl groups, 4-hydroxyphenyl groups and 2-hydroxyphenyl groups.

It is desirable that R in formula (I) be a group represented by formula (II) below:

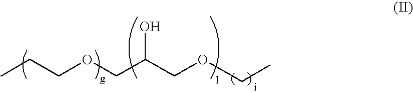

wherein, in formula (II), g is an integer of 0 to 3; 1 is an integer of 0 to 1; and i is an integer of 0 to 10.

Of these, the use of direct bonds, —CH₂—CH(OH)CH₂O—(CH₂)₃— and —(CH₂)₃— is desirable.

A¹ to A¹¹ in the organosiloxane groups are, respectively and independently, substituents selected from H, alkyl groups that may be substituted and aryl groups that may be substituted. Desirable examples include H, methyl groups, ethyl groups, propyl groups, butyl groups, pentyl groups, hexyl groups, 2-ethylhexyl groups, octyl groups, decyl group, undecyl groups, dodecyl groups, octadecyl groups, cyclohexyl groups, benzyl groups, phenyl groups, naphthyl groups and groups represented by formula (V) indicated below:

(CH₂)ₚO(CH₂CH₂O)_{q}R⁵¹ (V)

wherein, in formula (V), p is an integer of 0 to 10, q is an integer of 0 to 200, and R⁵¹ is a hydrogen atom or an alkyl group of 1 to 10 carbon atoms.

Of these, H, methyl groups, ethyl groups, phenyl groups, (CH₂)₃OH and (CH₂)₃O(CH₂CH₂O)H are preferable.

In formula (I), k is an integer of 0 to 10, and a, b and c, respectively and independently, are integers of 0 to 10, excepting the case k=a=b=c=0. Organosiloxane groups, the use of which is particularly desirable, are tris(trimethylsiloxy)silyl groups, tris(dimethylsiloxy)silyl groups, tris(hydroxypropyldimethylsiloxy)silyl groups and tris(hydroxyethoxypropyldimethylsiloxy)silyl groups in which all of k, a, b and c denote 1 and bis(trimethylsiloxy)methylsilyl groups, bis(dimethylsiloxy)methylsilyl groups, bis(hydroxypropyldimethylsiloxy)methylsilyl groups and bis(hydroxyethoxypropyldimethylsiloxy)methylsilyl groups in which a denotes 0 and k, b and c denote 1.

There are cases in which either one of monomer (a) and hydrophilic component (b), for example, have a group having an active hydrogen such as a hydroxyl group or a thiol group and the other has an isocynate group or an acid anhydride group, or there are cases in which one has an —SiH group and the other has an allyl group that can undergo a hydrosilylation reaction. Of these, the case in which the monomer (a) has an hydroxyl group or an —SiH group is preferable. In order to introduce them into the monomer (a), substituents having —CH₂—CH(OH)CH₂O—(CH₂)₃— as R in formula (I); H, (CH₂)₃OH or (CH₂)₃O(CH₂CH₂O)H as A¹ to A¹¹ in formula (I); or hydroxyl groups as R³¹ in formulas (x1) and (x2) can preferably be used.

Of the monomers (a) indicated above, monomers as indicated by formulas (m1) to (m12) below are desirable from the standpoint of modified balance between oxygen permeability and wettablity, and of these, the monomers of formulas (m1) to (m4) and (m10) to (m12) are more preferable:

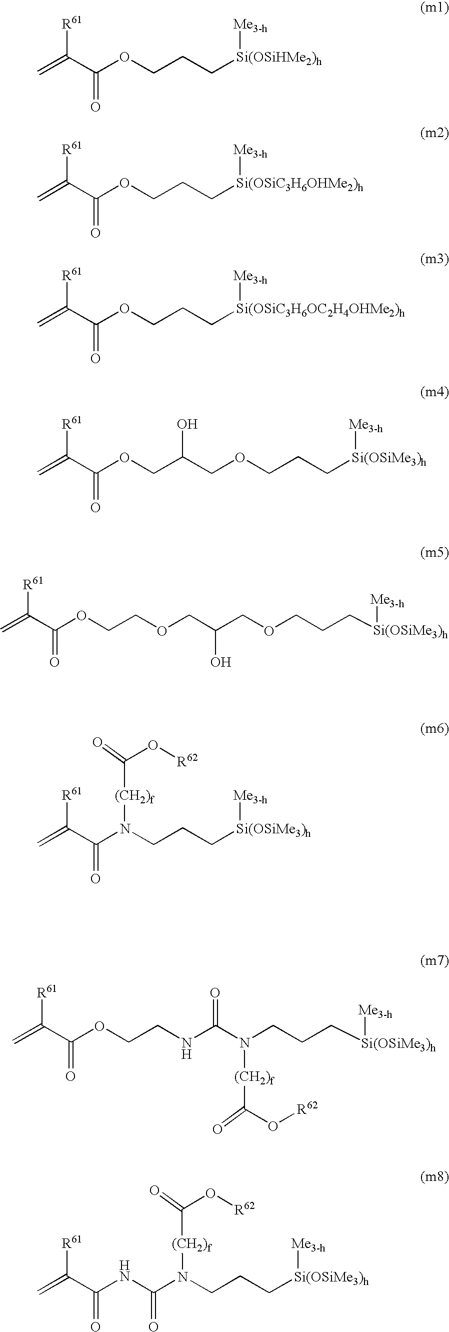

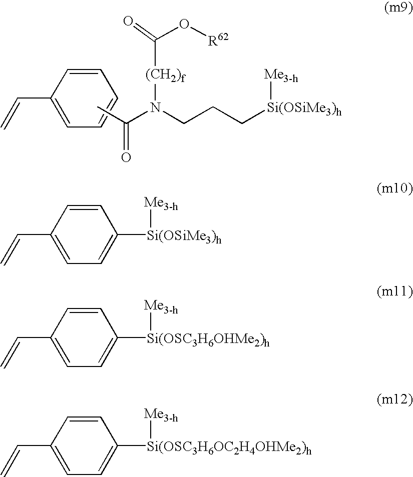

wherein, in formulas (m1) to (m12), R⁶¹ is H or a methyl group; R⁶² is a substituent selected from H, an alkyl group that may be substituted and an aryl group that may be substituted; h is an integer of 1 to 3; and f is an integer of 1 to 10.

Specific examples of R⁶² that can be cited include methyl groups, ethyl groups, propyl groups, isopropyl groups, butyl groups, isobutyl groups, sec-butyl groups, tert-butyl groups, pentyl groups, hexyl groups, 2-ethylhexyl groups, octyl groups, decyl groups, undecyl groups, dodecyl groups, octadecyl groups, cyclopentyl groups, cyclohexyl groups, benzyl groups, hydroxymethyl groups, 2-hydroxyethyl groups, 2-hydroxypropyl groups, 3-hydroxypropyl groups, 2,3-dihydroxypropyl groups, 2-hydroxybutyl groups, 4-hydroxybutyl groups, 2-hydroxypentyl groups, 5-hydroxypentyl groups, 2-hydroxyhexyl groups, 6-hydroxyhexyl groups, 3-methoxy-2-hydroxypropyl groups, 3-ethoxy-2-hydroxypropyl groups, phenyl groups, 4-hydroxyphenyl groups, 2-hydroxyphenyl groups, 4-methoxy phenyl groups and 2-methoxyphenyl groups. Substituents having hydroxyl groups are desirable to use from the standpoint of reactions with the hydrophilic component (b).

The polymers that are used in this invention may contain, as structural components, compounds that do not contain active groups that can react with the hydrophilic component (b) and that have only organosiloxane groups and polymerizable groups having carbon-carbon unsaturated bonds, in addition to the aforementioned monomers (a). Suitable examples of such components can include tris(trimethylsiloxy)silylpropyl (meth)acrylate, bis(trimethylsiloxy)methylsilylpropyl (meth)acrylate, tris(trimethylsiloxy)silyl styrene and bis(trimethylsiloxy)methylsilyl styrene. Further, the polymers that are used in this invention can contain siloxane macromonomers as structural components.

The polymers that are used in this invention may also contain, as structural components, the monomers (a) and monomers in addition to the components containing other organosiloxane groups. In this case, there are no limitations on the monomers as long as they are copolymerizable, and monomers having (meth)acryloyl groups, styryl groups, allyl groups, vinyl groups and other polymerizable carbon-carbon unsaturated bonds can be used. Examples are listed below but are not limited to them. They can include (meth)acrylic acid, itaconic acid, crotonic acid, cinnamic acid, vinyl benzoic acid, alkyl (meth)acrylates such as methyl (meth)acrylate and ethyl (meth)acrylate; polyfunctional (meth)acrylates such as polyalkylene glycol mono(meth)acrylate, polyalkylene glycol monoalkyl ether (meth)acrylate, polyalkylene glycolbis(meth)acrylate, trimethylolpropanetris(meth)acrylate and pentaerythritol tetrakis(meth)acrylate; halogenated alkyl (meth)acrylates such as trifluoroethyl (meth)acrylate and hexafluoroisopropyl (meth)acrylate; hydroxyalkyl (meth)acrylates having hydroxyl groups such as 2-hydroxyethyl (meth)acrylate and 2,3-dihydroxypropyl (meth)acrylate; (meth)acrylamides such as N,N-dimethylacrylamide, N,N-diethylacrylamide, N,N-di-n-propylacrylamide, N,N-diisopropylacrylamide, N,N-di-n-butylacrylamide, N-acryloyl morpholine, N-acryloyl piperidine, N-acryloyl pyrrolidine and N-methyl (meth)acrylamide; aromatic vinyl monomers such as styrene, α-methylstyrene and vinyl pyridine; heterocyclic vinyl monomers such as maleimides and N-vinyl pyrrolidone; and N-vinyl carboxylic acid amides. Several types of these monomers may be used at the same time.

It is desirable that the polymers of this invention contain monomers having two or more polymerizable carbon-carbon unsaturated bonds in one molecule as structural components for the purpose of obtaining good mechanical properties and good resistance to disinfectant solutions and wash solutions. The copolymerization ratio of monomers having two or more polymerizable carbon-carbon unsaturated bonds in one molecule should be 0.01 weight % to 10 weight %.

The total copolymerization ratio of monomers (a) and monomers containing other organosiloxane groups in the polymers of this invention, from the standpoints of achieving high oxygen permeability and high hydrophilic properties together with wettability, should be 30 weight % to 99 weight %, preferably, 50 weight % to 98 weight %, and, more preferably, 60 weight % to 95 weight %. Of these, it is desirable for the monomer (a) to be 0.1 to 50 weight % of the total. Several types of monomers containing other organosiloxane groups may be used at the same time as monomer (a).

When a hydrophilic monomer is copolymerized in the polymers that are used in this invention, hydrogels having the physical property of pliability can be obtained as a result of hydration. When a hydrophobic monomer is used as the copolymerization monomer, materials that are hard and of superior oxygen permeability are obtained.

The polymers that are used in this invention may also contain ultraviolet absorbents, pigments and colorants. Further, ultraviolet absorbents, pigments and colorants having polymerizable groups may also be present in copolymerized form.

When the polymers that are used in this invention are obtained by polymerization, it is desirable to add thermal polymerization initiators and photopolymerization initiators of which peroxides and azo compounds are representative in order to facilitate polymerization. When thermal polymerization is performed, substances having optimum decomposition properties at the desired reaction temperatures should be selected and used. In general, azo initiators and peroxide initiators having 10 hour half-life temperatures of 40 to 120° C. are desirable. Photopolymerization initiators that can be cited include carbonyl compounds, peroxides, azo compounds, sulfur compounds, halogen compounds and metal salts. These polymerization initiators can be used individually or in mixtures. They can be used in quantities of up to approximately 1 weight %.

When the polymers that are used in this invention are obtained by polymerization, a polymerization solvent can be used. There are no particular limitations on the solvents and various organic and inorganic solvents can be used. Examples that can be cited include water, alcohol solvents such as methyl alcohol, ethyl alcohol, normal propyl alcohol, isopropyl alcohol, normal butyl alcohol, isobutyl alcohol and tert-butyl alcohol; glycol ether solvents such as methyl cellosolve, ethyl cellosolve, isopropyl cellosolve, butyl cellosolve, propylene glycol monomethyl ether, ethylene glycol dimethyl ether, diethylene glycol dimethyl ether and triethylene glycol dimethyl ether; ester solvents such as ethyl acetate, butyl acetate, amyl acetate, ethyl lactate and methyl benzoate; aliphatic hydrocarbon solvents such as normal hexane, normal heptane and normal octane; alicyclic hydrocarbon solvents such as cyclohexane and ethyl cyclohexane; ketone solvents such as acetone, methyl ethyl ketone and methyl isobutyl ketone; aromatic hydrocarbon solvents such as benzene, toluene and xylene; and various petroleum solvents. They can be used individually or in mixtures.

Known methods can be used as polymerization methods and molding methods of the polymers that are used in this invention. For example, there is a method in which they are polymerized and molded into rods or plates and are then processed to the desired shape by cutting and processing, a mold polymerization method and a spin cast polymerization method.

The method of manufacture of the polymers for ophthalmic lenses of this invention is a method in which polymers for ophthalmic lenses of superior wettability are obtained by reacting a polymer containing, as a structural component, a monomer (a) obtained as described above with a hydrophilic component (b) having groups that can react with the active group contained in the monomer (a).

The hydrophilic component (b) that is used in this invention is preferably at least one compound selected from acid anhydrides, compounds represented by formula (III) and compounds represented by formula (IV):

CH₂═CH—CH₂—O(CH₂CH₂O)ᵣR⁴¹ (III)

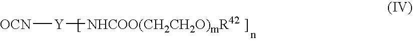

wherein, in formulas (III) and (IV), r is an integer of 0 to 500; n is an integer of 1 or 2; R⁴¹ is hydrogen or an alkyl group that may be substituted; Y is a residue obtained by eliminating NCO groups from isocyanate compounds having two or more functionality; m is an integer of 1 to 500; and R⁴² is an alkyl group that may be substituted.

It is desirable to use cyclic acid anhydrides as the acid anhydrides because they react with hydroxyl groups to form esters and also form another carboxyl group so that wettability is remarkably improved. Examples of suitable cyclic acid anhydrides include succinic acid anhydrides, maleic acid anhydrides, glutaric acid anhydrides and phthalic acid anhydrides.

Desirable hydrophilic components indicated by formula (III) include monoallyl ethers of (alkoxy)polyethylene glycol. Excellent wettability can be obtained by reacting them with —SiH groups in the presence of platinum compounds which are catalysts of the hydrosilylation reaction.

Desirable examples of hydrophilic components indicated by formula (IV) include bifunctional or higher isocyanate compounds such as isophorone diisocyanate and xylylene diisocyanate and compounds that react with (alkoxy)polyethylene glycol to leave one isocyanate group.

Hydrophilic treatment can be performed and polymers for ophthalmic lenses can be manufactured by bringing polymers containing the monomer (a) into contact with a solution obtained by dissolving or dispersing these hydrophilic components (b) in a solvent that does not impair the reaction. Specific examples include, for example, methods in which the polymer is immersed in a solution containing the hydrophilic component (b), methods in which said solution is sprayed onto the polymer, methods in which said solution is applied to the polymer with a spatula or a brush and methods in which said solution is applied to the polymer by a spin coat method or a dip coat method. The method whereby a great modifying effect can be obtained most simply is the method in which said polymer is immersed in said solution containing the hydrophilic component (b).

There are no particular limitations on temperature when the polymer is immersed in the solution containing the hydrophilic component (b). However, it is ordinarily performed within a temperature range of about −50° C. to about 200° C. When workability is considered, a temperature range of −10° C. to 150° C. is desirable and −5° C. to 80° C. is most desirable.

The optimum duration of immersion of the polymer in said solution varies depending on the temperature. Generally, it should be up to 100 hours, preferably, up to 24 hours and, more preferably, up to 12 hours. When contact time is excessively long, workability and productivity become poor and there are instances in which deleterious effects such as decrease in oxygen permeability appear.

The solvent for said solution may be any solvent as long as it does not impede the reaction. The substances may be in incompletely dissolved or dispersed states and various solvents can be used. For example, they can be various alcohols such as methanol, ethanol, propanol, 2-propanol, butanol, ethylene glycol, diethylene glycol, triethylene glycol, tetraethylene glycol, polyethylene glycol and glycerol; various aromatic hydrocarbons such as benzene, toluene and xylene; various aliphatic hydrocarbons such as hexane, heptane, octane, decane, petroleum ether, kerosene, ligroin and paraffin; various ketones such as acetone, methyl ethyl ketone and methyl isobutyl ketone; various esters such as ethyl acetate, butyl acetate, methyl benzoate and dioctyl phthalate; various ethers such as diethyl ether, tetrahydrofuran, dioxane, ethylene glycol dialkyl ether, diethylene glycol dialkyl ether, triethylene glycol dialkyl ether, tetraethylene glycol dialkyl ether and polyethylene glycol dialkyl ether; various nonprotonic polar solvents such as dimethylformamide, dimethylacetamide, N-methyl-2-pyrrolidone, dimethyl imidazolidinone, hexamethyl phosphoric triamide and dimethyl sulfoxide; halogenated solvents such as methylene chloride, chloroform, dichloroethane trichloroethane and trichloroethylene; and freon solvents. Of these, the use of ether compounds such as diethylene glycol dialkyl ethers and of alcohol compounds such as isopropyl alcohol is desirable because they are readily miscible with water and can easily be removed in subsequent processes. Mixtures of two or more substances can be used as solvents.

The solution containing the hydrophilic component (b) that is used in the aforementioned treatment may also contain the hydrophilic component (b) and components other than the solvent.

After said solution treatment, the excess hydrophilic component (b) that has not reacted with the monomer (a) can be removed from the polymer by washing. Various inorganic and organic solvents can be used as the wash solvents. For example, they can include water; various alcohols such as methanol, ethanol, propanol, 2-propanol, butanol, ethylene glycol, diethylene glycol, triethylene glycol, tetraethylene glycol, polyethylene glycol and glycerol; various aromatic hydrocarbons such as benzene, toluene and xylene; various aliphatic hydrocarbons such as hexane, heptane, octane, decane, petroleum ether, kerosene, ligroin and paraffin; various ketones such as acetone, methyl ethyl ketone and methyl isobutyl ketone; various esters such as ethyl acetate, butyl acetate, methyl benzoate and dioctyl phthalate; various ethers such as diethyl ether, tetrahydrofuran, dioxane, ethylene glycol dialkyl ether, diethylene glycol dialkyl ether, triethylene glycol dialkyl ether, tetraethylene glycol dialkyl ether and polyethylene glycol dialkyl ether; various nonprotonic polar solvents such as dimethylformamide, dimethylacetamide, N-methyl-2-pyrrolidone, dimethyl imidazolidinone, hexamethyl phosphoric triamide and dimethyl sulfoxide; halogenated solvents such as methylene chloride, chloroform, dichloroethane trichloroethane and trichloroethylene; and freon solvents. Mixtures of two or more solvents can be used as the wash solvents. The wash solvent may contain components in addition to the solvent, for example, inorganic salts, surfactants and detergents.

When the polymer of this invention is used as an ophthalmic lens, the wettability should be such that the dynamic contact angle (immersion rate during advance, 0.1 min/sec) for pure water is 110° or less, preferably, 90° or less and, most preferably, 80° or less. In the case of a hydrogel ophthalmic lens such as a soft contact lens, the water content should be 5% to 70%, preferably, 10% to 65% and, most preferably, 20% to 60%. The oxygen permeability coefficient [(cm²/sec)(mLO₂/(mL·hPa))] should be greater than 45×10⁻¹¹, preferably, greater than 50×10⁻¹¹ and, most preferably, greater than 60×10⁻¹¹ in terms of the oxygen permeability. In the case of hydrogel ophthalmic lenses, serious consideration is given to pliability, for which reason the tensile elastic modulus should be 0.1 to 2 MPa.

The method of manufacture of polymers for ophthalmic lenses of this invention is particularly suited to the manufacture of polymers for ophthalmic lenses such as contact lenses, intraocular lenses and artificial cornea of superior wettability and oxygen permeability.

### EXAMPLES

We shall now describe this invention in specific terms by means of examples. However, this invention is not limited by them.

Determination Methods

The various determinations in these examples were performed by the methods described below.

(1) Proton Nuclear Magnetic Resonance Spectrum

Determinations were performed using a Model EX270 manufactured by JEOL Ltd. Chloroform-d was used as the solvent.

(2) Infrared Absorption Spectrum

Determinations were made using a Model FTS-7 manufactured by Bio-Rad Laboratories, Inc. It was measured on rock salt plate by a liquid film method.

(3) Dynamic Angle of Contact

A sample, in the form of film, having a size on the order of 5 mm×10 mm×0.2 mm cut from a substance in the contact lens shape was used, and the dynamic angle of contact was determined during advance in pure water using a Model WET-6000 manufactured by Rhesca Co., Ltd. The immersion speed was 0.1 mm/second and the immersion depth was 7 mm.

(4) Oxygen Permeability Coefficient

The oxygen permeability coefficient in water of 35° C. was determined using a Seikaken-shiki film oxygen permeability meter manufactured by RIKA SEIKI KOGYO Co., Ltd.

(5) Modulus of Elasticity (Tensile Modulus of Elasticity)

A sample [width (smallest part), 5 mm; length, 14 mm; thickness, on the order of 0.2 mm] was cut from a substance in the contact lens shape using a stipulated punch mold, and determinations were made using a Model RTM-100 Tensilon manufactured by Orientec Corporation. The drawing rate was set to 100 mm/min and the distance between grips was set to 5 mm.

(6) Water Content

A sample in the form of a contact lens was used. The sample was dried for 16 hours at 40° C. in a vacuum dryer and the weight (Wd) of the sample was determined. Following that, it was immersed in pure water and was impregnated with water overnight in a constant temperature tank at 40° C., after which the water on the surface was wiped off with Kimwipe and its weight (Ww) was measured. The water content was found by the following formula.

Water content (%)=100×(Ww−Wd)/Ww

Synthesis 1

The compound of formula (J1) (manufactured by Shin-Etsu Chemical Co,. Ltd., 101.0 g), hydroquinone (0.24 g) and potassium hydroxide (1.95 g) were introduced into a 200 ml three-neck distillation flask equipped with a condensing tube, a stirrer and a dropping funnel, and methacrylic acid (51.7 g) was added dropwise over a period of approximately 30 minutes in a nitrogen atmosphere as the mixture was being stirred at room temperature. After the dropwise addition had been completed, a reaction was carried out for 8 hours at 100° C. as the mixture was being stirred. The materials were allowed to stand overnight, after which hexane (50 ml) was added and the mixture was stirred for 2 hours at room temperature. The insoluble matter was removed by filtration and the hexane solution was washed several times with 0.5 M sodium hydroxide, after which it was washed three times with a saturated saline solution. Anhydrous magnesium sulfate was added and dehydration was effected, after which the magnesium sulfate was removed by filtration and the solvent was removed with a rotary vacuum evaporator. The volatile components were removed under reduced pressure and at 60° C. over a four hour period, and a colorless transparent liquid (57.7 g) was obtained. The proton nuclear magnetic resonance spectrum was determined and analyzed, and, as a result, it was confirmed that the principal component was the monomer containing a silicon group as represented by formula (M1) from the fact that peaks were detected in the vicinity of 0.1 ppm (21H), in the vicinity of 0.4 ppm (2H), in the vicinity of 1.6 ppm (2H), in the vicinity of 1.9 ppm (3H), in the vicinity of 2.6 ppm (1H), in the vicinity of 3.3 to 4.3 ppm (7H), in the vicinity of 5.6 ppm (1H) and in the vicinity of 6.1 ppm (1H).

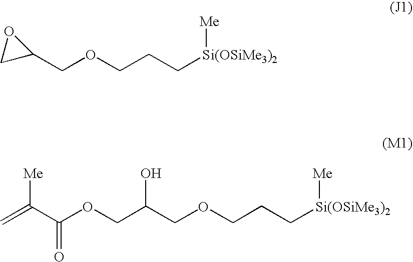

Synthesis 2

Hexane (50 g), methanol (50 g) and water (100 g) were introduced into a 1 liter three-neck distillation flask equipped with a stirrer and a dropping funnel. The flask was immersed in an ice bath and a mixture of 3-methacryloxypropyl trimethoxysilane (J2) (74.5 g) and dimethyl chlorosilane (170 g) was added dropwise over an approximately 1 hour period as the contents of the flask were being stirred vigorously with a three-one motor. After the dropwise addition was completed, the mixture was stirred for 3 hours at 5 to 20° C. When water (approximately 200 ml) was added, the mixture was separated into two layers and the top layer was collected with a separatory funnel. It was washed with a saturated sodium carbonate aqueous solution, saturated saline solution, saturated sodium hydrogencarbonate aqueous solution and saturated saline solution in that order. Dehydration was performed with anhydrous sodium sulfate, after which the solvent was removed with a rotary vacuum evaporator. Purification was performed by depressurization distillation and a colorless transparent liquid (106.4 g) was obtained. As a result of determination and analysis of the proton nuclear magnetic resonance spectrum, it was confirmed that the principal component was 3-methacryloxypropyltris(dimethylsiloxy)silane as represented by formula (M2).

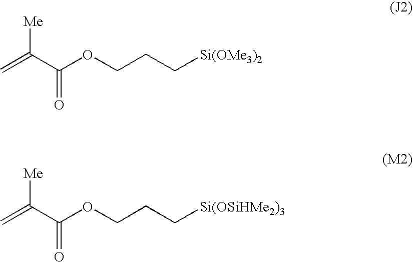

Synthesis 3

A compound (40 g) of which the principal component was a compound of formula (M2) obtained in Synthesis 2 described above, ethylene glycol monoallyl ether (40 g), isopropyl alcohol (100 g), a 10% ethanol solution (1 g) of potassium acetate and a 0.5% isopropyl alcohol solution (1 g) of chloroplatinic acid were introduced into a 500 ml three-neck distillation flask equipped with a stirrer and a reflux condenser. The mixture was heated for 7 hours as the isopropyl alcohol was being refluxed. The isopropyl alcohol was removed by means of a rotary vacuum evaporator, after which 200 ml of ethyl acetate and a saturated saline solution were added. When this was done, the mixture was separated into two layers and the top layer was collected with a separatory funnel. It was washed 5 times with a saturated saline solution and was dehydrated with anhydrous sodium sulfate. The solvent was removed with a rotary vacuum evaporator and a colorless transparent liquid (32.6 g) was obtained. It was confirmed from the infrared absorption spectrum that absorption attributable to —SiH in the vicinity of 2200 cm⁻¹ was extinguished, and it was confirmed that the compound represented by formula (M3) was the principal component.

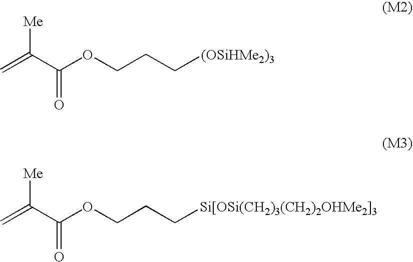

Synthesis 4

Isophorone diisocyanate (17.6 g) represented by formula (J3), methoxy polyethylene glycol (160 g) of a molecular weight of approximately 2000, diethylene glycol dimethyl ether (240 g) that had been dehydrated by a molecular sieve and 0.035 g of dibutyltin laurate were introduced into a 1 liter three-neck distillation flask equipped with a stirrer and a reflux condenser, a reaction was carried out by heating for 12 hours at 60° C. in a nitrogen atmosphere, and the compound represented by formula (M4) was obtained. It was confirmed from the infrared absorption spectrum that absorption attributable to isocyanate in the vicinity of 2290 cm⁻¹ had been reduced by half, and it was confirmed that the isophorone diisocyanate and the methoxy polyethylene glycol had reacted with each other.

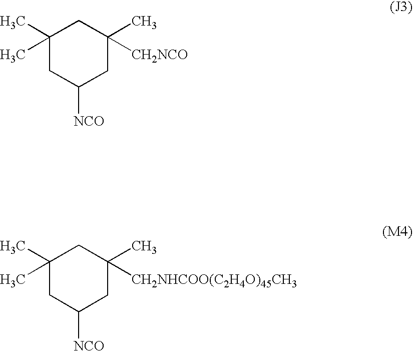

### Example 1

The organosiloxane group-containing monomer (30 parts by weight) obtained in Synthesis 1, tris(trimethylsiloxy)silylpropyl methacrylate (30 parts by weight), N,N-dimethyl acrylamide (40 parts by weight), polyethylene glycol dimethacrylate (“Blenmer” PDE600, manufactured by NOF CORPORATION; 1 part by weight) and diethylene glycol dimethyl ether (20 parts by weight) were mixed uniformly and “Darocure” 1173 (manufactured by CIBA Specialty Chemicals Inc.; 0.5 part by weight) was added as a polymerization initiator, after which this monomer mixture was deaerated in an argon atmosphere. It was then poured into a contact lens mold made of a transparent resin (poly 4-methylpentene-1) in a glove box in a nitrogen atmosphere, polymerization was performed by photo-irradiation (1 mW/cm², 30 minutes) using an inset attraction lamp, and a lens-shaped sample was obtained.

The lens-shaped sample that was obtained was immersed in the solution that was obtained in Synthesis 4, and the materials were heated for 12 hours at 60° C. After the reaction was completed, it was immersed successively in aqueous solutions of diethylene glycol dimethyl ether, the concentrations of which were decreased. Finally, it was immersed in pure water and a hydrogel lens was obtained. This lens was sealed in a vial filled with a boric acid buffer solution (pH 7.1 to 7.3) and was subjected to boiling treatment for 30 minutes at 121° C. After it had cooled, the lens-shaped sample was removed from the vial and immersed in pure water. The table below shows the physical properties of the sample that was obtained and of an untreated sample. By comparison to the untreated sample, it can be seen that the contact angle was decreased and that there were improved properties.

TABLE 1

| | Untreated | Treated |
|---|---|---|
| | sample | sample |
| Water content | 36% | 40% |
| Advancing contact angle | 90° | 78° |
| Modulus of elasticity | 0.69 MPa | 0.55 MPa |
| Oxygen permeability coefficient | 71 × 10⁻¹¹ | 71 × 10⁻¹¹ |
| [(cm²/sec) (mLO₂/(mL · hPa))] | | |

### Example 2

The organosiloxane group-containing monomer (40 parts by weight) obtained in Synthesis 1, tris(trimethylsiloxy)silylpropyl methacrylate (20 parts by weight), N,N-dimethyl acrylamide (20 parts by weight), polyethylene glycol dimethacrylate (“Blenmer” PDE600, manufactured by NOF CORPORATION; 1 part by weight) and diethylene glycol dimethyl ether (20 parts by weight) were mixed uniformly, and a lens-shaped sample was obtained in the same way as in Example 1.

The lens-shaped sample that was obtained was immersed in a mixed solution of 20 g of triethylamine, 0.4 g of succinic anhydride and 0.16 g of pyridine, and the materials were stirred slowly for 9 hours at room temperature. After the reaction was completed, successive solution replacement was performed in the same way as in Example 1 and a hydrogel lens was obtained. It was subjected similarly to boiling treatment for 30 minutes at 121° C. The table below shows the physical properties of the sample that was obtained and of an untreated sample. By comparison to the untreated sample, it can be seen that the contact angle was greatly decreased and that there were marked improving effects.

TABLE 2

| | Untreated sample | Treated sample |
|---|---|---|
| Water content | 10% | 28% |
| Advancing contact angle | 90° | 55° |

### Example 3

The organosiloxane group-containing monomer (10 parts by weight) obtained in Synthesis 2, tris(trimethylsiloxy)silylpropyl methacrylate (55 parts by weight), N,N-dimethyl acrylamide (35 parts by weight), triethylene glycol dimethacrylate (0.5 part by weight) and diethylene glycol dimethyl ether (20 parts by weight) were mixed uniformly, and a lens-shaped sample was obtained in the same way as in Example 1.

The lens-shaped sample that was obtained was immersed in a mixed solution of 20 g of polyethylene glycol monoallyl ether of a molecular weight of approximately 1500, 80 g of diethylene glycol dimethyl ether that had been dehydrated with molecular sieve and 0.02 g of chloroplatinic acid, and a reaction was carried out for 9 hours at 60° C. After the reaction was completed, solutions were replaced successively in the same way as in Example 1 and a hydrogel lens was obtained. It was subjected similarly to boiling treatment for 30 minutes at 121° C. The table below shows the physical properties of the sample that was obtained and of an untreated sample. By comparison to the untreated sample, it can be seen that the contact angle was greatly decreased and that there were marked improvement in properties. It can also be seen that there was a superior balance of other physical properties.

TABLE 3

| | Untreated | Treated |
|---|---|---|
| | sample | sample |
| Water content | 25% | 40% |
| Advancing contact angle | 90° | 65° |
| Modulus of elasticity | 0.69 MPa | 0.62 MPa |
| Oxygen permeability coefficient | 94 × 10⁻¹¹ | 71 × 10⁻¹¹ |
| [(cm²/sec) (mLO₂/(mL · hPa))] | | |

### Example 4

The organosiloxane group-containing monomer (10 parts by weight) obtained in Synthesis 3, tris(trimethylsiloxy)silylpropyl methacrylate (55 parts by weight), N,N-dimethyl acrylamide (35 parts by weight), triethylene glycol dimethacrylate (0.5 part by weight) and diethylene glycol dimethyl ether (20 parts by weight) were mixed uniformly, and a lens-shaped sample was obtained in the same way as in Example 1.

The lens-shaped sample that was obtained was immersed, in the same way as in Example 1, in a diethylene glycol dimethyl ether solution of an equimolar addition product of the isophorone diisocynate and the methoxypolyethylene glycol monomethacrylate of a molecular weight of approximately 2000, both obtained in Synthesis 4, after 0.035 g of dibutyltin laurate had been added, and it was heated for 7 hours at 60° C. After the reaction was completed, solutions were replaced successively in the same way as in Example 1 and a hydrogel lens was obtained. It was subjected to boiling treatment for 30 minutes. The table below shows the physical properties of the sample that was obtained and of an untreated sample. By comparison to the untreated sample, it can be seen that the contact angle was greatly decreased and that there were marked improvement in properties. It can also be seen that there was a superior balance of other physical properties.

TABLE 4

| | Untreated | Treated |
|---|---|---|
| | sample | sample |
| Water content | 32% | 42% |
| Advancing contact angle | 90° | 65° |
| Modulus of elasticity | 0.76 MPa | 0.55 MPa |
| Oxygen permeability coefficient | 86 × 10⁻¹¹ | 75 × 10⁻¹¹ |
| [ml(STP)cm · cm⁻² · sec⁻¹ · mmHg⁻¹] | | |

### INDUSTRIAL APPLICABILITY

By means of this invention, polymers for ophthalmic lenses of high oxygen permeability and superior wettability can be obtained.

1. A method for manufacturing polymers for ophthalmic lenses comprising reacting a polymer having, as a polymerization component, at least one monomer (a) having organosiloxane groups and a polymerizable group having a carbon-carbon unsaturated bond with at least one hydrophilic component (b).

2. The method of claim 1 wherein the monomer (a) is at least one monomer that is selected from a group represented by formula (I) below: 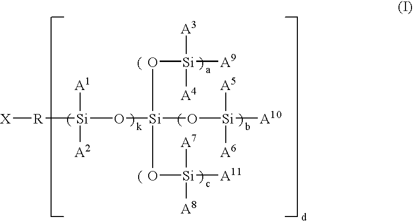
wherein, X is a polymerizable group having carbon-carbon unsaturated bonds; R is selected from the group consisting of alkyl groups that may contain ether bonds and that may be substituted; A¹ to A¹¹ are independently selected from the group consisting of H, alkyl groups that may be substituted and aryl groups that may be substituted; k is an integer of 0 to 10; a, b and c are, respectively and independently, integers of 0 to 10, excepting the case k=a=b=c=0; and d is an integer of 1 or 2.

3. The method of claim 2 wherein X is (x1) or (x2) as indicated below: 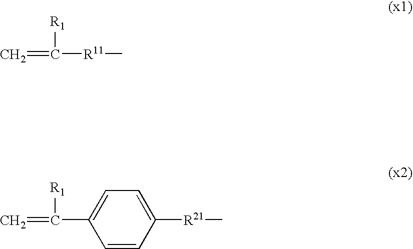
wherein, in formulas (x1) and (x2), R¹ is H or a methyl group; R¹¹ is selected from the group consisting of —COO—, —COO(CH₂)₂NHCONR³¹—,—CONHCONR³¹— and —CONR³¹—; R²¹ is a direct bond and —CONR³¹—; and R³¹ is a substituent selected from the group consisting of a hydrogen atom, an alkyl group that may be substituted and an aryl group that may be substituted.

4. The method of claim 2 wherein R in formula (I) is represented by formula (II) below: 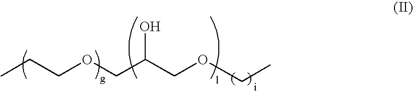
wherein, in formula (II), g is an integer of 0 to 3; 1 is an integer of 0 to 1; and i is an integer of 0 to 10.

5. The method of claim 1 wherein the hydrophilic component (b) is at least one compound selected from acid anhydrides, compounds represented by formula (III) and compounds represented by formula (IV):
CH₂═CH—CH₂—O(CH₂CH₂O)ᵣR⁴¹ (III)
OCN—Y—[—NHCOO(CH₂CH₂O)ₘR⁴²]ₙ (IV)
wherein, in formulas (III) and (IV), r is an integer of 0 to 500; R⁴¹ is hydrogen or an alkyl group that may be substituted; m is an integer of 1 to 500; Y is a residue obtained by eliminating NCO groups from isocyanate compounds having two or more functionality; and R⁴² is an alkyl group that may be substituted.

6. An ophthalmic lens comprising polymers which are formed by chemical bonding of a polymer having, as a polymerization component, at least one monomer (a) selected from a group represented by the above formula (I) with at least one hydrophilic component (b) selected from acid anhydride, compounds represented by the above formula (III) and compounds represented by the above formula (IV).
